(19) United States
(12) Patent Application Publication
(10) Pub. No.: US 2025/0041809 A1
(43) Pub. Date: Feb. 6, 2025

(54) SYSTEMS AND METHODS FOR ATMOSPHERIC DISPERSION OF OXIDANT FOR NET CONVERSION OF ATMOSPHERIC METHANE TO CARBON DIOXIDE

(71) Applicant: Scott Christopher Bell, Calgary (CA)

(72) Inventor: Scott Christopher Bell, Calgary (CA)

(21) Appl. No.: 18/717,420

(22) PCT Filed: Dec. 14, 2022
(86) PCT No.: PCT/CA2022/051824

§ 371 Date: Jun. 6, 2024

Related U.S. Application Data
(60) Provisional application No. 63/290,540, filed on Dec. 16, 2021.

(51) Int. Cl. B01F 23/213; B01D 53/72; B01D 53/76; B01F 35/21; B01F 35/221; B01F 35/71; C01B 32/50

(52) U.S. Cl. CPC B01F 23/2132; B01D 53/72; B01D 53/76; B01F 35/2115; B01F 35/2131; B01F 35/2132; B01F 35/2211; B01F 35/7176; C01B 32/50; B01D 2257/7025; B01D 2258/06

(57) ABSTRACT

Systems and methods for dispersing oxidizing agents in the atmosphere to effect conversion of atmospheric methane to carbon dioxide are described. The system includes oxidizing agent delivery systems, elevated dispersion systems and associated control systems to control dispersion based on current and/or modelled atmospheric composition, atmospheric conditions and location specific parameters.

### FIELD OF THE INVENTION

Systems and methods for dispersing oxidizing agents in the atmosphere to effect conversion of atmospheric methane to carbon dioxide are described. The system includes elevated dispersion systems and associated control systems to control dispersion based on current and/or modelled atmospheric conditions and location specific parameters.

### BACKGROUND OF THE INVENTION

Methane is a greenhouse gas (GHG) that compared to carbon dioxide (CO₂) has a greater atmospheric heating effect. For example, the 20-year global warming potential of methane is 84, meaning that over a 20-year period, methane traps 84 times more heat per mass unit than carbon dioxide. Global methane concentrations rose from 722 parts per billion (ppb) in pre-industrial times to about 1900 ppb by 2020, an increase by a factor of 2.5 and the highest value in at least 800,000 years.

There are both human-derived and natural sources of methane that enter the atmosphere. Various human-derived sources include landfills, farm animals, energy industry sources including gas flaring and coal mining; and natural sources include wetlands, lakes and the methane sinks including the vast stores of methane beneath the world's oceans, glaciers, and permafrost.

Importantly, methane sinks are susceptible to atmospheric temperature increase in that some methane such as methane within permafrost is released when permafrost melts. As such, increasing atmospheric temperature can create a positive-feedback where increased amounts of methane being released may contribute to increased atmospheric temperatures which in turn causes additional methane to be released from the earth.

Currently, global annual methane emissions from the earth are estimated to exceed annual atmospheric destruction of methane by 57 mega tonnes (MT). However, large scale release events driven by global warming which may include natural/glacial/permafrost/methane hydrate sources have the potential to release over 1000 MT of methane per year.

As nations seek to either encourage or enact a broad range of actions to reduce their GHG burden, there are significant advantages to large scale, single point, and low-cost technologies that can reduce GHG emissions without relying on individual companies, groups, or nations to take a particular course of action. That is, placing the impetus and financial burden on individuals and companies is frequently met with political and economic opposition.

Various technologies to reduce GHG emissions from point sources face significant challenge to scalability. Such technologies often rely on government programs which are routinely at risk of being cancelled or defunded which will prevent deployment and/or substantially slow down deployment. Moreover, as there can be limited financial incentives to develop such technologies given various complexities including coordination and support from industry, government, and operations stakeholders, financing from traditional institutions may be impossible. In comparison, large scale projects supported by government can be more efficient (economically and socially) to develop and maintain.

Government action in the past has been shown to be effective against chemicals being released into the atmosphere. For example, once the scientific community recognized the effect of chloro-fluorocarbons (CFCs) being released on atmospheric ozone and through the Montreal protocol, cooperative effort to ban the use and release of ozone depleting CFCs the expansion of the ‘ozone holes’ over earth's poles has been heralded as a success. In addition, issues regarding acid rain were effectively addressed by government action.

As varying amounts of CFCs, carbon monoxide, VOCs and many other atmospheric contaminants continue to be released into the atmosphere as a result of unregulated emissions from human activity, there is a need for effective technologies to remove, destroy, or convert these compounds from or in the atmosphere. Importantly, centralized technologies also have the potential to more effectively create a market for carbon credits.

A review of the prior art indicates various technologies aimed to oxidize atmospheric methane emissions to carbon dioxide. Such technologies include using industrial equipment such as tungsten catalysts, UV lights, gas turbines, or separators and combustors. However, due to the relatively low concentration of atmospheric methane and the cost of equipment and other required inputs (power, heat, light, etc.) many of these technologies are uneconomical with current carbon tax pricing.

Methane may spontaneously react to form carbon dioxide in the atmosphere by various pathways including nitrogen dioxide (NO₂) catalyzed reactions. A representative reaction pathway to convert methane to carbon dioxide is shown in FIG. 1 for an OH initiated, NOx catalyzed oxidation of methane to carbon dioxide. In this reaction scheme, formaldehyde (HCHO) and carbon monoxide (CO) are intermediate oxidized products with the formation of four ozone (O₃) molecules.

As a result, there has been a need for GHG reducing technologies utilizing non-polluting or negatively polluting chemistry with reasonable economics to enable GHG reduction.

### SUMMARY OF THE INVENTION

In accordance with the invention, there is provided a system for dispersing an oxidizing agent (OA) in an atmosphere comprising: a source of OA; an OA delivery system including at least one pump connected to the OA storage system; an OA dispersion system connected to the OA delivery system, the OA dispersion system including a nozzle system for dispersing OA into the atmosphere; and, wherein the OA dispersion system is elevated relative to a ground surface.

In various embodiments:
The OA dispersion system is mounted on a tower and the tower is greater than 30 m in height.
The OA dispersion system is mounted on a tower and the tower is greater than or equal to 100 m in height.
The OA dispersion system is mounted on a tower and the tower is greater than or equal to 600 m in height.
The OA dispersion system is mounted on a tower and the tower is greater than or equal to 1000 m in height.
The OA delivery system includes at least one liquid pump for pumping liquid OA to the dispersion system and at least one air flow pump for pumping air to the dispersion system and where the dispersion system mixes liquid and air prior to delivery to the nozzle system.
The system includes a controller connected to the OA delivery system and at least one sensor connected to the controller wherein data from the at least one sensor provides input data to the controller to increase or decrease a pump rate of the at least one pump and a flow rate of OA to the atmosphere.
The at least one sensor is a wind speed and wind direction sensor and flow rate is adjusted based on a combination of both wind speed and wind direction.
The at least one sensor includes any one of or a combination of a temperature sensor and a ultraviolet light sensor.
The system includes aerial input data and wherein the controller assesses aerial images as an input for pump control.
The system includes weather input data and the controller assesses weather data as an input for pump control.
The system includes at least one ground, drone, or aircraft mounted OA and/or methane concentration sensor and the controller assesses OA concentration data as an input for pump control.
The OA storage system, OA delivery system and OA dispersion system are within and aerial vehicle.
The OA is selected from any one of or a combination of hydrogen peroxide, nitrous acid (HNO₂), ozone (O₃), superoxide (H₂O₃) or salt aerosols including sodium chloride (NaCl), calcium chloride (CaCl₂)), magnesium chloride (MgCl₂) and iron chloride (FeCl₄).
The OA dispersion system is mounted to an airship tethered to a ground surface and includes a pipe system between the ground surface and the airship.

In another aspect, the invention provides a method for converting methane to carbon dioxide in the atmosphere comprising the steps of: dispersing an oxidizing agent (OA) into the atmosphere including the steps of pumping an OA from an OA storage system to a dispersion system at an elevated height relative to a ground surface.

In various embodiments, the method includes the steps of pumping liquid OA to the dispersion system, pumping air to the dispersion system and mixing the liquid and air prior to atmospheric dispersion and/or increasing or decreasing a flow rate of OA to the dispersion system based on input data from at least one sensor connected to the controller and wherein the at least one sensor includes any one of or a combination of a wind speed sensor, wind direction sensor, ultraviolet light sensor, and temperature sensor.

### BRIEF DESCRIPTION OF THE DRAWINGS

Various objects, features and advantages of the invention will be apparent from the following description of particular embodiments of the invention, as illustrated in the accompanying drawings. The drawings are not necessarily to scale, emphasis instead being placed upon illustrating the principles of various embodiments of the invention. Similar reference numerals indicate similar components.

FIG. 1 is a representative nitrogen dioxide catalyzed reaction scheme for methane conversion to carbon dioxide in accordance with the prior art (Source: M. E. Jenkin et. Al. (2008): A Common Representative Intermediates (CRI) mechanism for VOC degradation. Part 1: Gas mechanism development. Elsevier, Atmospheric Environment 42 (2008) 7185-7195. Doi: 10.1016/j.atmosenv.2008.07.028.

FIG. 2 is a representative process flow diagram (PFD) for oxidizing agent (OA) distribution from an elevated tower showing equipment and high-level flowlines for hydroxide storage and elevation.

FIG. 3A is a representative graph showing predicted ground concentration of an OA at a range of distances from a source for a 30 m height.

FIG. 3B is a representative graph showing predicted ground concentration of an OA at a range of distances from a source for a 100 m height.

FIG. 3C is a representative graph showing predicted ground concentration of an OA at a range of distances from a source for a 300 m height.

FIG. 3D is a representative graph showing predicted ground concentration of an OA at a range of distances from a source for a 600 m height.

FIG. 4 is a figure showing representative plume shape vs. distance (Source: https://commons.wikimedia.org/wiki/File: Gaussian_Plume_(SVG).svg).

FIG. 5 is a schematic diagram showing a control system for controlling flow of an OA to atmosphere based on input from a variety of sensors.

FIG. 6 is a graphical representation of estimated efficiency of conversion of methane using hydrogen peroxide OA at various concentrations vs. atmospheric NOx concentration in clean air with 20 ppb ozone.

FIG. 7 is a graphical representation of modelled H₂O₂ equilibrium concentrations in air at various temperatures to illustrate the influence of temperature on atmospheric dispersion of OA.

### DETAILED DESCRIPTION OF THE INVENTION

With reference to the figures, systems and methods for converting atmospheric methane to carbon dioxide are described.

### Rationale

As a potent greenhouse gas with an estimated global atmospheric increase of 57 MT per year, methane is estimated to be responsible for 16% of current global warming effects over the next 100 years. By converting atmospheric methane to carbon dioxide, the GHG burden in the atmosphere is effectively reduced by 27-35 tCO2e for each tonne of methane converted, on a basis of 100 years. Note that 25 tCO2e remains used for carbon credits calculations in some jurisdictions.

### Introduction

As described below, the invention utilizes oxidizing agent (OA) distribution technologies at elevation to effect conversion of methane to carbon dioxide. The processes described benefit from natural resources such as wind to distribute the oxidizing agent and drive conversion to reactive oxidizing species utilizing sunlight.

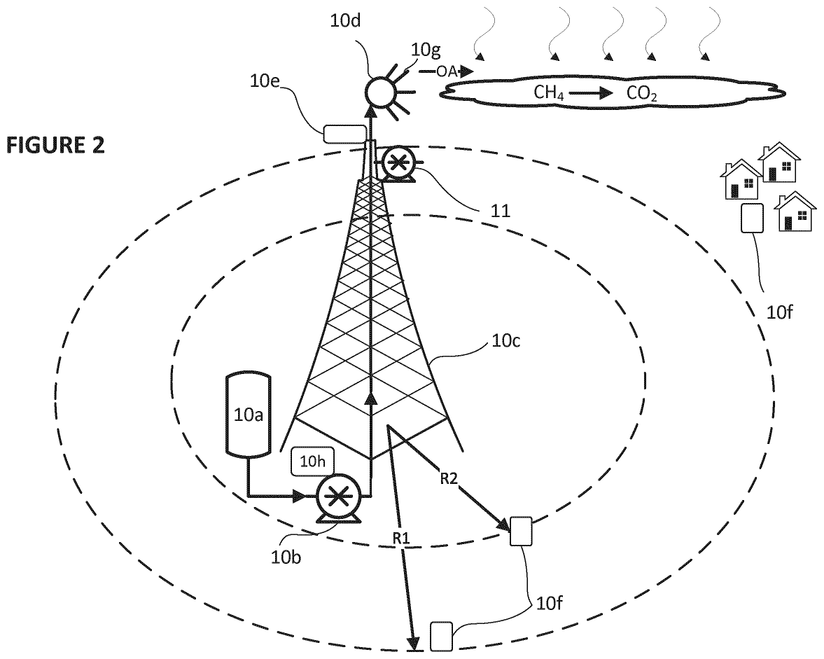

Various aspects of the invention are described with reference to FIGS. 2-7. For the purposes of illustration, components depicted in the figures are not necessarily drawn to scale. Instead, emphasis is placed on highlighting the various contributions of the components to the functionality of various aspects of the invention. A number of possible alternative features are introduced during the course of this description. It is to be understood that, according to the knowledge and judgment of persons skilled in the art, such alternative features may be substituted in various combinations to arrive at different embodiments of the present invention.

In addition, the atmospheric chemistry described herein is not to be held to any particular theory and it is understood that the chemical processes described herein are illustrative only.

As is known, like most hydrocarbons, methane is a common worldwide energy source and contains a high amount of potential chemical energy. Methane is also stable under atmospheric conditions, with an autoignition temperature of 537 C (810 K). By creating conditions which favor the oxidation of methane, the molecule follows thermodynamically favorable decomposition pathways resulting in the formation of carbon dioxide and water.

With reference to FIG. 2, in a first embodiment, a tower distribution system 10 includes an oxidizing agent (OA) storage tank 10a, OA pump 10b, tower 10c, air pump/aerosol system 11 and dispersion/nozzle system 10d. The system includes a mast sensor package 10e and may further include additional fixed, drone, or aerial sensors 10f installed or deployed at various distances and locations away from the tower 10c.

OA is pumped from the storage tank 10e to the top of the tower and is combined with air to create an aerosol 10g that is emitted through the dispersion system 10d into the atmosphere. The OA reacts with sunlight 12 and atmospheric methane, and via various reaction pathways, methane is converted to carbon dioxide. In various embodiments, the OA may be pumped to the top of the tower in gaseous or liquid form and/or combined with air at ground level or on the tower. In other embodiments, the OA/air can be heated to improve mixing/dispersion.

In one representative embodiment, the OA is hydrogen peroxide which reacts with UV light to convert methane to carbon dioxide.

H₂O₂+UVC→2OH⁻ (Eq 1)

CH₄+OH⁻→CH₃⁻+H₂O (Eq 2)

CH₃⁻+O₂→HCO⁻+H₂O (Eq 3)

HCO⁻+O₂→CO+HO₂ (Eq 4)

CO+OH⁻→CO₂+H⁻ (Eq 5)

As per Eq 1, exposure of hydrogen peroxide to UV light forms hydroxyl radical (OH). Hydroxyl radical reacts with methane (Eq 2) which ultimately can be converted to carbon dioxide via additional reactions involving the hydroperoxyl radical (HO₂) (Eq 3-Eq 5).

Further, the hydroperoxyl radical may react with water to regenerate OH⁻ and hydrogen peroxide (Eq 6) and/or with ozone to regenerate OH⁻ and oxygen (Eq 7).

Possible regeneration reactions via HO₂:

HO₂+H₂O→OH⁻+H₂O₂ (Eq 6)

HO₂+O₃⁻→2O₂+OH⁻ (Eq 7)

Methane conversion rates will vary based on various scenarios including scenarios where no regeneration of OA occurs, such as illustrated in Eq. 7, and where substantial regeneration occurs (e.g. 50-100%) via reactions like Eq. 6. Such reactions will be dependent on numerous factors including time of day, location and/or current atmospheric conditions and composition.

### Examples

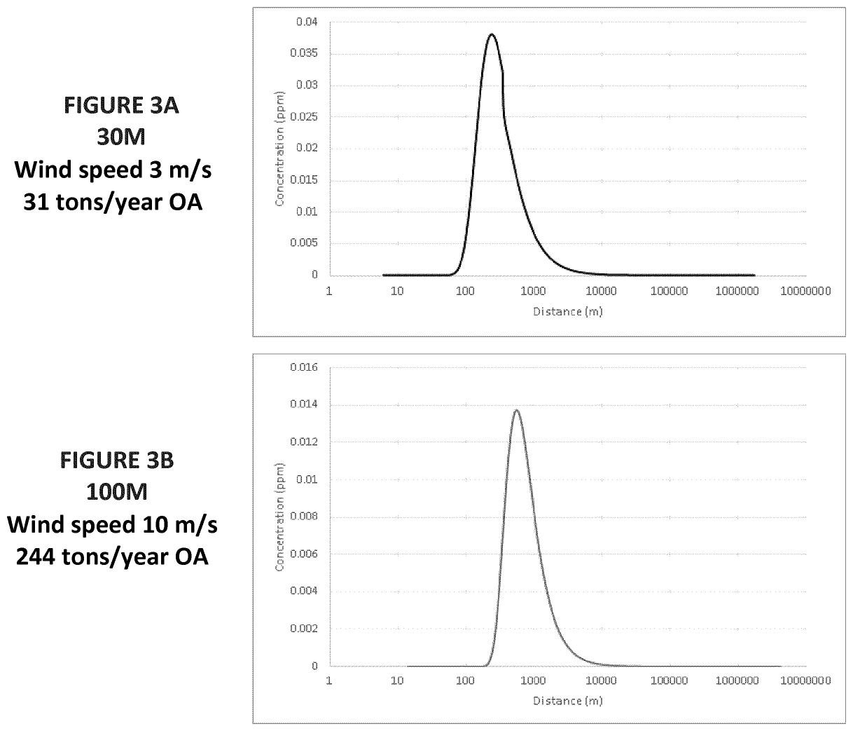

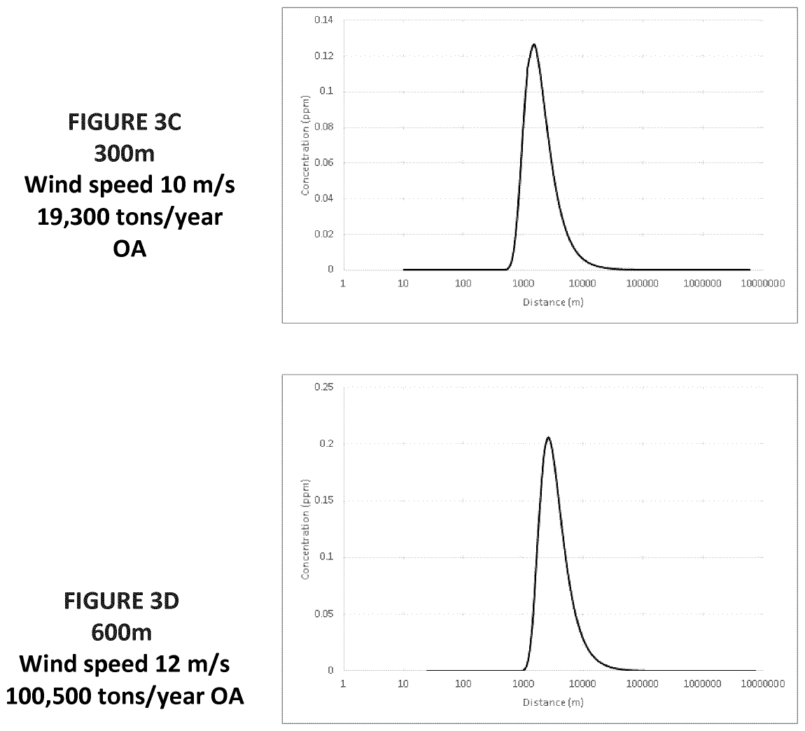

Various modelled examples are described with reference to FIGS. 3A-3D and show representative plume distribution/conversion models for varying plume heights. Models may include various assumptions including:
Hydrogen peroxide is released into the atmosphere where it reacts with sunlight to form hydroxyl radicals.
Hydroxyl radicals react with methane to initiate oxidation to carbon dioxide.
The reaction rate of hydrogen peroxide with light to OH⁻ based on photon density and wavelength.
Each mole of methane removed will consume varying mols of hydroxyl radicals, including side reactions, based on plume modelled concentrations.
Varying mols of hydroxyl radicals react with methane.
Various side reactions including hydroxyl reaction with carbon monoxide or VOCs and oxidizing them to carbon dioxide can occur.
Competing side reactions between hydroxyl radical, hydrogen peroxide, and water, hinder the economic conversion of methane at elevated hydroxyl radical concentrations.

The addition of OA into the atmosphere at height provides time and volume for conversion reactions to occur without providing unsafe OA concentrations at ground. That is, it is generally important over land masses that include sensitive environmental areas and/or that are in close proximity to animal/human populations that the risk of unsafe concentrations of OA reaching the ground near a dispersion mast is effectively managed.

In this regard, generally as the height of OA dispersion is increased, there is more time available for dispersion and for conversion reactions to occur. In addition, the system can take advantage of improved atmospheric conditions for the conversion reactions.

That is, as height increases, winds tend to increase and UV intensity is higher. Higher winds enable greater volumes/mass of OA to be introduced as the winds will increase the distance and hence dispersion of an OA relative to the tower before potentially coming into contact with ground. As a result, as dispersion height is increased, proportionally greater volumes/mass of OA can be introduced as compared to a lower dispersion height.

In each of the examples below, fixed variables of wind speed and mast height inter alia demonstrate that with an increase in mast height, proportionally greater volume/mass of OA can be responsibly dispersed.

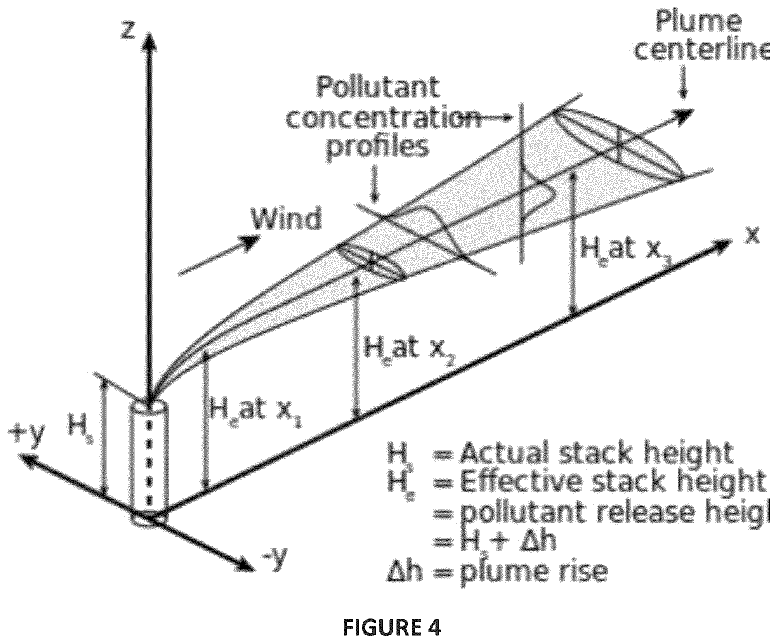

As shown in FIGS. 3A-3D and 4, representative dispersion characteristics and concentration vs. distance of an OA dispersed from a source at different heights are shown. The Figures show that to ensure an acceptable OA concentration at ground level, the relative mass of OA that can be dispersed is an important factor, together with variables such as wind speed and the mast height.

FIG. 3A shows modelled data for a 30 m mast height and an assumed wind speed of 3 m/s. This graph shows that approximately 31 tons/year of OA can be dispersed with a maximum predicted ground level OA concentration of about 0.04 ppm at 300-500 meters from the mast.

FIG. 3B, shows modelled data for a 100 m mast height and a wind speed of 10 m/s. This graph shows that approximately 244 tons/year of OA can be dispersed with a maximum predicted ground level OA concentration of 0.014 ppm at about 500-700 meters from the mast.

FIG. 3C, shows modelled data for a 300 m mast height and a wind speed of 10 m/s. This graph shows that approximately 19,300 tons/year of OA can be dispersed with a maximum predicted ground level OA concentration of 0.12 ppm at about 2000 meters from the mast.

FIG. 3D shows modelled data for a 600 m mast height and a wind speed of 12 m/s. This graph shows that approximately 100,500 tons/year of OA can be dispersed with a maximum predicted ground level OA concentration of 0.2 ppm at about 5000-7000 meters from the mast.

Accordingly, by approximately increasing the mast height from 30 m to 600 m, proportionally greater volume/mass of OA can be dispersed as mast height increases. OA volumes/mass dispersion is also positively affected by typically higher wind speeds and higher UV levels experienced at higher heights.

### Control and Sensor System

As noted above, as atmospheric conditions are variable, conversion rates will vary in accordance with those variations. For example, a drop in wind speed would generally decrease dispersion and could increase ground OA concentration levels if the same volume of OA is dispersed. Hence, as wind speed decreases, a reduction in flow rate of OA through the dispersion system may be necessary.

Various parameters that may be monitored for controlling dispersion can include:
animal/human factors including proximity to populated areas and habitats.
geographical/environmental features including:
   hills and valleys.
   biological ground cover.
   bodies of water.
general climate including:
   seasonal affects of latitude.
   presence of wild fires.
   seasonal high/low pressure systems.
current weather conditions including:
   cloud cover.
   UV index.
   temperature.
   temperature layering and inversions.
   wind speed.
   wind direction.
   rainfall.
   lightning strikes or potential thereof.
Imaging
   Satellite/Aircraft imaging for 3D plume determination/measurement.
   Ground based optical monitoring or imaging for maximum point concentration or 3D plume determination/measurement
Chemical Monitoring
   Drone or ground based deployment of methane and hydrogen peroxide laser based sensors with ppb point resolution to confirm and correct modelled plume characteristics.

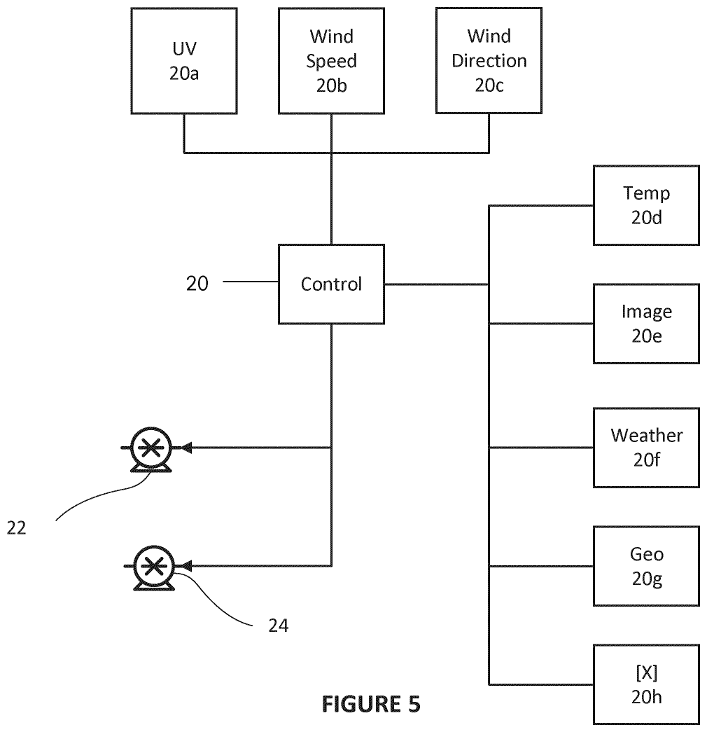

Each of the above can provide modelled or direct feedback to a control system as shown in FIG. 5. For example, a controller 20 may be connected to a variety of sensors 20a to 20h, and to OA pump(s) 22 and air pump(s) 24. Inputs from each sensor may be received by the controller 20 and based on various algorithms used to control the flow rates through pumps 22 and 24. As shown, various mast sensors may include UV sensors 20a, windspeed sensors 20b, wind direction sensors 20c and temperature sensors 20d. Other data input into the controller may include aerial image data from other sources 20e, geographical data 20g (humans, animals, environment etc.) and/or other relevant weather data (storms, lightning, etc.). Ground concentration sensors 20h located at or beyond the mast may also provide relevant input into the controller.

In one example, direct feedback from a wind speed and wind direction sensor may be used to control OA feed rate wherein feed rate may be adjusted for various combinations of wind speed and direction. If humans, animals or sensitive areas are located in one direction, flow rates may be adjusted downwardly if the wind direction and speed is within particular ranges, whereas if the wind direction is away from human, animal or sensitive areas, flow rates may be adjusted upwardly particularly if the associated ground is less sensitive to OAs.

In addition, direct measurement of parameters such as temperature and UV photon flux and wavelength levels can be similarly considered, where increased temperatures may assist in promoting reaction rates and/or dispersion and increased UV levels in specific wavelengths may assist in promoting reaction rates.

Depending on the location, specific geographical features may also be considered in the control of dispersion flow rates. For example, wind speeds may be affected by valleys/mountains and be important in OA dispersion under certain conditions.

Feedback can be provided by geographically distributed sensors and/or by models. That is, area models may be created based on data located over a period of time in a particular area to provide input to a control system. Such models, may thereafter, not require direct input data from sensors. Alternatively, area sensors may be employed.

In a preferred embodiment, the tower 10c can take the form of a signal broadcasting tower having piping running up along the tower for carrying OA. The dispersion rate of OA is determined as a factor of equilibrium OA concentration, air crossflow and other safety factors.

The nozzles of the nozzle dispersion system 10d can preferably arrange to provide a maximum cross section of OA dispersion taking into account air crossflow. The nozzle dispersion system 10d may preferably include an excess number of nozzles, each having on/off control, and more preferably also with flowrate control, to thereby vary and control dispervion volumes based on wind speed, atmospheric composition, temperature and other factors. Further preferably, the number of nozzles in the dispersion system 10d are planned based on a winter worst case scenario.

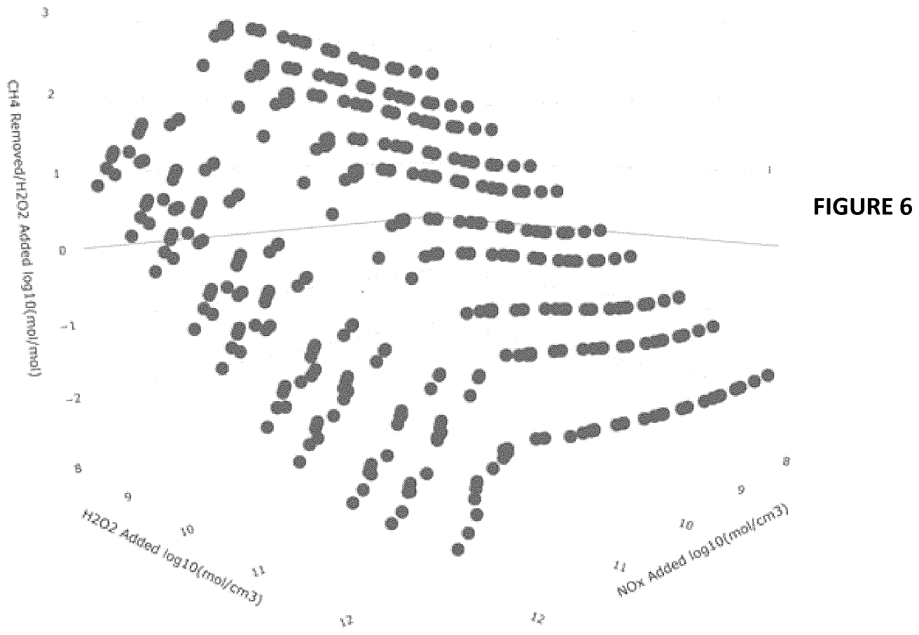

As illustrated in FIG. 6, concentrations of reactants are important to the design of any chemical process. FIG. 6 shows an example where H₂O₂ is added to enhance atmospheric degradation of methane, and NOx is already present at various concentrations at various locations in the earth's atmosphere. By modeling the effectiveness of the addition of H₂O₂ on methane conversion to CO₂, the economics of the process may be estimated at a range of conditions.

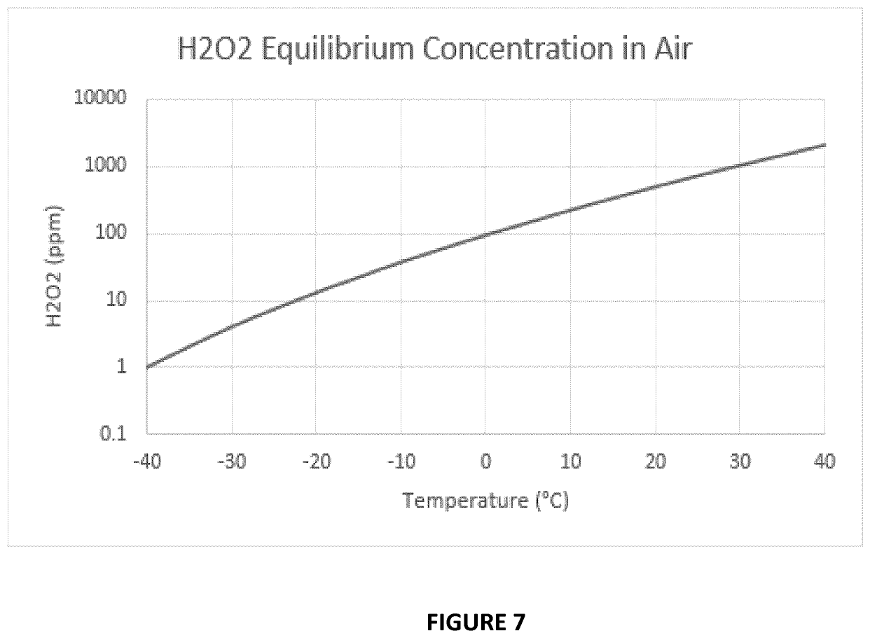

FIG. 7 shows that equilibrium OA concentration will vary with temperature.

Table 1 shows an example of predicted performance of a 300 m tower operating with input parameters shown in Table 1 including wind speed, source OA concentration and vent rate. Table 1 shows that at a 10 m/s wind speed, with 1,224 m² air crossflow area, a 50-500 ppm source OA emissions concentration, 53 tons of OA can be dispersed per day. By way of reference, at atmospheric conditions and a temperature of 20° C. (293.15 K), hydrogen peroxide has a modelled maximum ambient concentration of roughly 500 ppm.

TABLE 1
Predicted Performance of a 300 m Tower

| | Summer | Winter | |
|---|---|---|---|
| Parameter | Value | Value | Units |
| Horizontal Wind Speed | 10 | 10 | m/s |
| Maximum OA Concentration (OA vapor | 500 | 50 | ppm |
| concentration leaving dispersion system) | | | |
| Mixing Air Crossflow Rate | 12,240 | 12,240 | m³/s |
| Source OA Dispersion Rate | 612 | | g/s |
| | 53 | | Tonnes/day |
| Losses to Ground | 0.1 | | Tonnes/day |
| Plume Height | 300 | | m |
| Effective OA Distribution | 19,264 | | Tonnes/year |
| Example Conversion Ratio | 1.0 | | tonne CH4/tonne |
| | | | H2O2 |
| Example Hydrogen Peroxide Emissions | 2.5 | | tCO2e/tH2O2 |
| Factor | | | |
| Carbon Credits | 414,176 | | tCO2e/year |
| Carbon Credit Price | $75 | | $/tCO2e |
| Example Incremental Cost of H2O2 | $1000 | | $/tonne H2O2 |
| Production at Existing Facility | | | |

| | |
|---|---|
| Carbon Credit Revenue Potential | $31,063,200 |
| Chemical Expense Estimate | $19,264,000 |
| Profit Potential | $11,799,200 |

TABLE 2
Breakeven Conversion Rate

| H2O2 + | | | | |
|---|---|---|---|---|
| Deployment | Breakeven Conversion Rate (mol CH4/molH2O2) | | | |
| Cost ($/tH2O2) | $50/tCO2e | $75/tCO2e | $100/tCO2e | $125/tCO2e |
| 2200 | 3.9 | 2.6 | 1.95 | 1.56 |
| 1800 | 3.19 | 2.13 | 1.60 | 1.28 |
| 1000 | 1.78 | 1.19 | 0.89 | 0.71 |
| 500 | 0.89 | 0.6 | 0.44 | 0.35 |
| 350 | 0.62 | 0.42 | 0.31 | 0.25 |

Thus, based on a $75/tCO₂e carbon credit price, the total annual potential revenue is approximately $11.8M and with OA costs and operational costs being estimated at $19.3M. Economics are improved when the present system is coupled with existing hydroxide production facilities, where marginal hydroxide costs may be used with incremental cost of production of $1000/tonne used for illustrative purposes. Market hydrogen peroxide prices are estimated at between $2200/tonne for future inflated H₂O₂ price, $1800/tonne for existing facilities and between $350 and $500/tonne of H₂O₂ for international purpose-built facilities with production capacities of or exceeding 1,000,000 tonnes of H₂O₂ per year.

Generally, as can be seen from Table 2 showing breakeven conversions at varying carbon credit prices, operation of such a mast dispersion system could be profitable at present and future carbon credit pricing.

### Oxidizing Agents

Hydrogen peroxide is a common household chemical. However, as a strong oxidizing agent, animal/human exposure cannot exceed an 8-hour exposure limit of 1 ppm in Canada.

Other oxidizing chemicals such as nitrous acid (HONO), direct release hydroxyl radical (OH—) or superoxide (H₂O₃) may provide similar degradation pathways for methane.

Other oxidizing chemicals can include salt aerosols including NaCl, calcium chloride (CaCl₂)), magnesium chloride (MgCl₂) and iron chloride (FeCl₄).

### Dispersion Systems

Various dispersion systems can include free-standing or supported mast/tower systems such as:
<=30 m: Flare Stack or single pipe support
<=80 m: Meteorological Mast or guyed support tower.
<=200 m: Communications Tower, guyed or self-supporting tower
<=2000 m: Broadcasting Tower, guyed or self-supporting tower

Depending on the benefits available at higher elevations, large scale deployment could make use of aerial or nautical deployment vehicles. Aerial vehicles or projectiles offer increased elevation with potential for deployment above the ozone layer. Ocean-based vehicles offer deployment in remote locations with low risk of exposure for life forms.

An aerial vehicle could include a tethered aerostat or airship or water-bomber aircraft or other aircraft for bulk liquids deployment. In a tethered airship embodiment, the system will include a piping system from an anchor point to the airship to enable delivery of OA to the airship. The anchor point of the airship may be a tower or a ground surface with the OA having a piping system from the anchor point.

Projectiles could include kinetic storage devices with controlled release at various elevations/pressures/velocities/accelerations.

Ocean-based system could include towers anchored to the ocean floor, floating towers tethered to the ocean floor, floating towers with engineered untethered supports, towers deployed on small islands, and/or boats/barges.

### Dispersion Systems

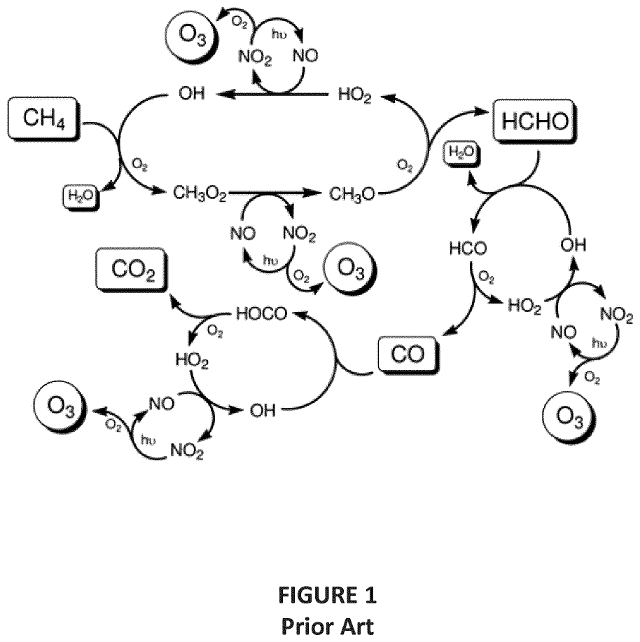

As shown in FIG. 1, for ground tower systems, OA may be released from various nozzles, atomizers, eductors, or vaporizers that may include heating elements to increase the temperature of air and hydrogen peroxide and/or vaporize hydrogen peroxide locally. Additional, dispersion systems such as fans or ducts to increase airflow for better mixing and dispersion locally may also be employed.

Although the present invention has been described and illustrated with respect to preferred embodiments and preferred uses thereof, it is not to be so limited since modifications and changes can be made therein which are within the full, intended scope of the invention as understood by those skilled in the art.

What is claimed is:

1. A system for dispersing an oxidizing agent (OA) in an atmosphere comprising:
a source of OA;
an OA delivery system including at least one pump connected to the OA storage system;
an OA dispersion system connected to the OA delivery system, the OA dispersion system including a nozzle system for dispersing OA into the atmosphere; and,
wherein the OA dispersion system is elevated relative to a ground surface.

2. The system as in claim 1 where the OA dispersion system is mounted on a tower and the tower is greater than 30 m in height.

3. The system as in claim 1 where the OA dispersion system is mounted on a tower and the tower is greater than 100 m in height.

4. The system as in claim 1 where the OA dispersion system is mounted on a tower and the tower is greater than 600 m in height.

5. The system as in claim 1 where the OA dispersion system is mounted on a tower and the tower is greater than 1000 m in height.

6. The system as in claim 5 wherein the OA delivery system includes at least one liquid pump for pumping liquid OA to the dispersion system and at least one air flow pump for pumping air to the dispersion system and where the dispersion system mixes liquid and air prior to delivery to the nozzle system.

7. The system as in claim 6 further comprising a controller connected to the OA delivery system and at least one sensor connected to the controller wherein data from the at least one sensor provides input data to the controller to increase or decrease a pump rate of the at least one pump and a flow rate of OA to the atmosphere.

8. The system as in claim 7 where the at least one sensor is a wind speed and wind direction sensor and flow rate is adjusted based on a combination of both wind speed and wind direction.

9. The system as in claim 8 where the at least one sensor includes any one of or a combination of a temperature sensor and a light sensor.

10. The system as in claim 9 further comprising aerial input data and wherein the controller assesses aerial images as an input for pump control.

11. The system as in claim 10 further comprising atmospheric composition input data and wherein the controller assesses composition as an input for pump control.

12. The system as in claim 11 further comprising weather input data and wherein the controller assesses weather data as an input for pump control.

13. The system as in claim 12 further comprising at least one ground OA concentration sensor and wherein the controller assesses OA concentration data as an input for pump control.

14. The system as in claim 13 wherein the OA storage system, OA delivery system and OA dispersion system are within an aerial vehicle.

15. The system as in claim 14 wherein the OA is selected from any one of or a combination of hydrogen peroxide, ozone (O₃) or superoxide (H₂O₃).

16. The system as in claim 14 wherein the OA is a salt aerosol selected from any one of or a combination of NaCl, calcium chloride (CaCl₂)), magnesium chloride (MgCl₂) and iron chloride (FeCl₄).

17. The system as in claim 1 where the OA dispersion system is mounted to an airship tethered to a ground surface and includes a pipe system between the ground surface and the airship.

18. A method for converting methane to carbon dioxide in the atmosphere comprising the steps of: dispersing an oxidizing agent (OA) into the atmosphere including the steps of pumping an OA from an OA storage system to a dispersion system at an elevated height relative to a ground surface.

19. The method as in claim 18 further comprising the steps of pumping liquid OA to the dispersion system, pumping air to the dispersion system and mixing the liquid and air prior to atmospheric dispersion.

20. The method as in claim 19 further comprising the step of increasing or decreasing a flow rate of OA to the dispersion system based on input data from at least one sensor connected to the controller and wherein the at least one sensor includes any one of or a combination of a wind speed sensor, wind direction sensor, light sensor, temperature sensor, and chemical sensor.
